(19) United States
(12) Patent Application Publication
(10) Pub. No.: US 2025/0086967 A1
(43) Pub. Date: Mar. 13, 2025

(54) DIGITAL MEASUREMENT, REPORTING AND VERIFICATION SYSTEM

(71) Applicant: Terra Vista Gestora De Rescursos Ltda., São Paulo (BR)

(72) Inventors: Luis Felipe ADAIME, Punta del Este (UY); Roger Rodrigues De Oliveira, Sâo Paulo (BR); Ana Pris Santos, São Paulo (BR)

(21) Appl. No.: 18/643,844

(22) Filed: Apr. 23, 2024

(30) Foreign Application Priority Data
Sep. 12, 2023 (BR) 10 2023 018463-4

(51) Int. Cl. G06V 20/10; G06Q 50/26; G06V 20/13; H04L 9/00

(52) U.S. Cl. CPC G06V 20/188; G06Q 50/26; G06V 20/13; H04L 9/50

(57) ABSTRACT

The present invention refers to a digital measurement, reporting and verification system with the option of using blockchain technology, which uses: official databases; satellite images; and algorithms; wherein the system also comprises: a measurement module configured to receive information from rural property registration, perform the total property calculation, evaluate the level of land regularity in the area using the databases and estimate the carbon stock; a reporting module configured to generate monitoring reports; and a verification module configured to validate the eligibility of a carbon credit project.

### APPLICATION FIELD

The present invention belongs to the application field of forest carbon conservation projects. More specifically, the present invention refers to a digital measurement, reporting and verification system for Reducing Emissions from Deforestation and Forest Degradation (REDD) projects.

### BACKGROUND OF THE INVENTION

In a forest carbon conservation project, a physical survey is usually performed at the site to be conserved, measuring trees with a tape measure in a process called “forest inventory”, this survey is highly costly, slow and aims to evaluate the forest area that is intended to be conserved and calculate the carbon potential this area has.

After implementing the project, it is necessary to monitor the area, with the aim of verifying whether the conservation area is being maintained, being entitled to the carbon credits granted to the area.

There are some systems known in the state of the art to calculate carbon credits.

US2014164070 discloses a probabilistic carbon credit calculator that can be used to calculate monetary values of carbon credits for geographic areas, time periods, land uses, climate scenarios, and other specific factors. The document further discloses a computer-implemented apparatus and method that receives specifications from a user indicating a geographic area to be assessed for monetary carbon credit value; obtains at least one prediction from a carbon model predicting quantities of terrestrial carbon in the geographic area; accesses carbon credit market data; calculates at least one monetary carbon credit value associated with the geographic area using the carbon credit market forecast and data; and displays the monetary value of the carbon credit.

U.S. Pat. No. 8,111,924 discloses a method based on remote sensing and probability sampling to determine the volume of potential carbon dioxide emissions caused by forest deforestation. The method comprises processing remote sensing data indicative of tree attribute information for said forest, said remote sensing data comprising at least one of LiDAR data and digital images; defining a sampling frame within said remote sensing data; further comprising determining a field plot corresponding to said sampling frame and collecting field plot data therefrom, said field plot data comprising actual tree attribute information; generating a correlated model by combining said field plot data with said remote sensing data corresponding to said sample frame; applying said correlated model to all said remote sensing data to produce a probabilistic forest inventory; and determining a probabilistic volume of carbon dioxide caused by potential deforestation of the forest using said probabilistic forest inventory.

U.S. Pat. No. 7,457,758 discloses a method and apparatus for determining standardized carbon emission reduction credits and, more particularly, a method and apparatus for generating, quantifying and confirming standardized carbon emission reduction credits and reserve carbon emission reduction credits. The method receives, retrieves, and processes data from a first field plot and general data from the geographic region encompassing the first field plot with a carbon sequestration model run on the computer system to determine a change in the level of carbon compounds stored in the soil during a first specified period of time; the method performs an uncertainty analysis on the determined change in the level of carbon compounds; identifies a total number of carbon emission reduction credits; and produces a report including the first quantity of standardized carbon emission reduction credits and the first quantity of reserve carbon emission reduction credits.

U.S. Pat. No. 8,504,252 discloses tools and techniques to enhance and/or facilitate the collection, tracking and/or verification of greenhouse gas emissions and/or savings, particularly (but not exclusively) in agricultural applications. The document discloses a system comprising a mobile unit, a position sensing device configured to track a location of a conservation cultivation activity; a soil monitoring device; a first communication system; a server computer; a second communication system; a data storage; a processor communicating with the second communication system and data storage; a computer-readable medium having stored therein a set of instructions executable by the processor to cause the server computer to perform one or more operations.

KR20220066534 discloses a system for estimating carbon stocks in forests. The system includes a data receiving unit configured to acquire image data including a plurality of tree images by aerial photography; a tree type determination unit; a tree growth information determination unit for discriminating growth information of the plurality of trees from the image data and the type of tree, and a calculation unit for calculating the amount of carbon storage of the trees constituting the image of the tree included in the image data, combining the amount of storage. Furthermore, the document discloses that image data can be acquired from a camera attached to a satellite.

US2013197814 discloses a method of quantifying soil carbon, particularly, a method of quantifying soil carbon based on a sampling strategy. The method comprises the steps of: obtaining an estimate of the spatial distribution of carbon content in the land unit; stratifying the land unit into a plurality of strata based at least in part on the spatial distribution of carbon content; selecting one or more locations from each of one or more of the plurality of strata, the one or more locations being selected randomly; determining the carbon content of the sample associated with one or more locations; and determining the total carbon content in the land unit based at least partially on the carbon content of the sample.

The steps of a forest carbon credit project must be developed based on good quality and recent data. Errors and uncertainties at this and the design step can lead to investment cancellations or unrealistic estimates of carbon credit generation.

The prior art discloses ways to calculate carbon credits. However, the methods and systems disclosed by the prior art are not automated and do not have a centralized database, making them low in reliability, significantly increasing the cost of the certification process, making audits difficult and making it impossible to completely eliminate on-site due diligence.

Comprising more than 716 million hectares analyzed in Brazil, the entire ecosystem involved with forest carbon projects is potentially benefiting from a digital system measuring, reporting and verifying forest carbon conservation projects.

Considering the above, there was a need to develop a system that automates the necessary processes for measuring, reporting and verifying carbon credits and that acts as a database centralizer.

### OBJECTIVES OF THE INVENTION

In order to solve the problems of the prior art, it is an objective of the present invention to show a digital measurement, reporting and verification system which optimizes and accelerates the development of REDD (Reduction of Emissions from Deforestation and Forest Degradation) projects, and has the option of using security to store information through blockchain.

Another objective of the present invention is to show a system that digitizes and automates the main necessary processes for measuring, reporting and verifying carbon credits (such as forest inventory and monitoring).

It is yet another objective of the present invention to speed up the development of REDD+ (Reduction of Greenhouse Gas Emissions from Deforestation and Forest Degradation+conservation of forest carbon stocks, sustainable management of forests and increase of forest carbon stocks) projects.

It is also the objective of the present invention to show a digital measurement, reporting and verification system having a centralized database.

It is also the objective of the present invention to automate and digitize the necessary steps to develop an avoided deforestation project, such as land due diligence of the territory to estimate carbon density in biomass and estimate the generation of carbon credits.

Finally, it is a further objective of the present invention to show a system providing information for planned and unplanned deforestation.

### SUMMARY OF THE INVENTION

In order to achieve the aforementioned objectives, the present invention refers to a digital measurement, reporting and verification system having the option of using blockchain for the security of information storage, said system being used for evaluation steps of technical feasibility of REDD+ projects (methodology established by the UN). The system in question also provides information for the type of planned, or legally authorized, deforestation and for the type of unplanned, or illegally occurring, deforestation.

In particular, the system uses official databases, satellite images and information processing methods. The databases used are public and private and obtained from geographic databases developed over years by agents from different sectors of the economy and based on robust methodologies, whether for the establishment of public policies or for the development of projects, such as for example, the World Database of Key Biodiversity Areas (KBA) from data provider BirdLife International, the Burning Database from INPE data provider and Carbon stock in pasture (IV National Emissions Inventory and Greenhouse Gas Removals and its Technical Reference Reports).

An advantage guaranteed by the system using this data from official sources is compatibility with national and global efforts for land, environmental and forest monitoring regularization. Furthermore, data providers are widely recognized by the scientific community and the international community related to the Agriculture, Forests and Other Land Use—AFOLU sector, providing the robustness, trust and transparency necessary for the system.

Additionally, it is an advantage of the invention to centralize all this geographic data in a single digital tool, through the automation of data consultation, obtaining, treatment, processing and systematization activities. Furthermore, it improves the performance of teams of specialists in the development of REDD+ projects, mainly in the land sector; and facilitates data observation by investors and auditors.

The system uses information processing methods configured to perform functions such as detecting forest disturbances, geospatial analysis to determine the eligible forest area and classifying each spectral response into land use categories such as pasture, agriculture, urban infrastructure, hydrology and vegetation native.

The system also comprises a measurement module configured to receive information from rural property registration, perform the total calculation of the property, evaluate the level of land regularity in the area using the databases and estimate the carbon stock of its forest; a reporting module configured to generate monitoring reports; and a verification module configured to validate the eligibility of a carbon credit project.

The measurement module also comprises an automated land due diligence step, wherein the registration of a natural or legal person is automated; a spatial limits step wherein the calculation of the total area of the property is automated; a restriction step, wherein the search and validation of registration in the rural environmental registration system (SICAR) and cross-referencing of this data with registration data in the land management system (SIGEF) are automated; and an eligibility step, wherein the process of assessing historical and current land use and calculating and evaluating eligible forest is automated.

The system also comprises a carbon stock estimation step, wherein the processes of estimating forest carbon stock, the relationship between above-ground and below-ground biomass, determining the ecological zone and estimating the carbon stock BAU scenario (business as usual, or alternative conservation scenario) are automated.

Carbon stock estimation allows the ex-ante estimation of carbon stocks in above- and below-ground trees and non-tree woody biomass for the baseline scenario, thus determining pre- and post-deforestation carbon stocks.

### BRIEF DESCRIPTION OF THE DRAWINGS

The subject matter of the present invention will be completely clear in its technical aspects from the detailed description that will be made based on the figures listed below, wherein:

FIG. 1 shows a schematic image of the functioning of the digital measurement, reporting and verification system;

FIG. 2 shows a flowchart of the steps of the measurement module;

FIG. 3 schematically shows the levels of complexity for obtaining data in a forest carbon credit project;

FIG. 4 shows an example of the presentation of data automatically consulted from the National Rural Environmental Registration System (SICAR);

FIG. 5 shows an example of the presentation of data automatically consulted in the Land Management System (SIGEF);

FIG. 6 shows the methodological steps to implement the land use and coverage classification of the MapBiomas public system;

FIG. 7 shows land cover and use in 1985 and 2017 in Brazilian biomes;

FIG. 8 shows the remaining and eligible forest area between the two historical years of analysis;

FIG. 9A shows a project area and buffers of 5, 20 and 50 km with the WDPA analysis;

FIG. 9B shows a project area and buffers of 5, 20 and 50 km with the KBA analysis;

FIG. 10 shows a forecast map of the change in tropical forest cover in America for the period between 2020 and 2100;

FIG. 11 shows a deforestation risk map at 30 m resolution and the 100×100 km map in the state of Mato Grosso;

FIG. 12 shows an example of data obtained by the system regarding the potential for generating APD (avoided planned deforestation) credits and AUD (avoided unplanned deforestation or illegal deforestation) credits of the area of interest;

FIG. 13 shows a schematic figure of inputs for forest monitoring;

FIG. 14 shows an example of a deforestation alert report identified on the registered rural property, created by the system of the present invention;

FIG. 15 shows an example of the descriptive memorial of the deforested area, prepared by the system of the present invention;

FIG. 16 shows a detection image of burning vegetation and other hot targets;

FIG. 17 shows a flowchart of the forest disturbance detection method;

FIG. 18 shows an example of detection and monitoring of disturbances in the forest through selective extraction;

FIG. 19 shows an example of an alert about the expansion of a logging road and selective extraction of wood; and

FIG. 20 shows a flowchart of the verification module steps.

### DETAILED DESCRIPTION OF THE INVENTION

In accordance with the aforementioned objectives and the figures showed, the present invention refers to a digital measurement, reporting and verification system having the option of using blockchain to guarantee the security of information storage.

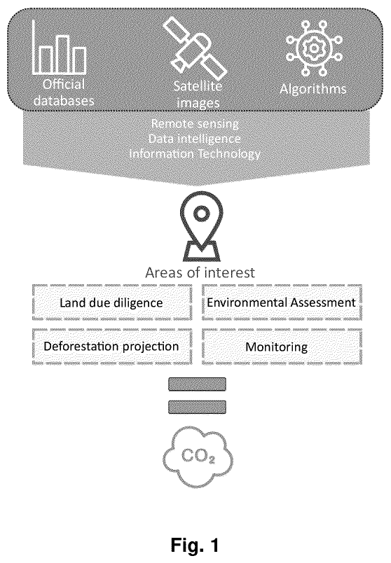

The system of the present invention is based on data that digitizes and automates the main processes necessary for the measurement, reporting and verification (MRV) of a private REDD+ project, and can be used in the steps of evaluating the technical feasibility of the project, its design and, to a lesser extent, implementation. The system provides information for both planned or legally authorized deforestation (“avoided planned deforestation”) and unplanned or illegally occurred (“avoided unplanned deforestation”) modality. The functioning of the system is briefly and graphically presented in FIG. 1.

The present invention makes it possible to develop a forest carbon credit project with the generation of carbon credits following global methodologies, as it allows the project steps to be developed based on good quality and recent data. For the project feasibility analysis step, the system allows increasing the level of automation in planning and analyzing the profitability of new businesses and reducing investment risks, as well as other types of uncertainties.

Table 1 shows an overview of each of the modules, steps and processes necessary for the origination of REDD+ carbon credits on private rural properties. These processes and their respective systems are constantly evolving and may be changed/modified in future versions.

TABLE 1
Modules, steps and processes of the system

| Module | Step | Processes | System |
|---|---|---|---|
| Measuring | Land Due | Consultation of the | Automates |
| | Diligence | registration of an | |
| | | individual or legal | |
| | | entity | |
| | | Gathering and evaluation | Does not perform |
| | | of documents | |
| | | Embargo assessment | Automates |
| | Spatial limits | Calculation of the total | Automates |
| | | area of the property | |
| | | Legal reserve surplus | Performs |
| | | analysis | |
| | | Definition of the reference | Performs |
| | | region | |
| | Temporal limits | Definition of the start date | Does not perform |
| | | and time limits | |
| | Carbon reservoirs | | Performs |
| | and greenhouse | | |
| | gases (GHG) | | |
| | Additionality | Barrier analysis, common | Performs |
| | | practice | |
| | Restrictions | Land 1: Overlays (CUs, TI, | Automates |
| | | PA) | |
| | | Land 2: Registration in CAR | Automates |
| | | Land 3: Registration in | Automates |
| | | SIGEF | |
| | | Land 4: Registration and full | Does not perform |
| | | certificate | |
| | Eligibility | Historical and current land | Automates |
| | | use | |
| | | Eligible Forest | Automates |
| | carbon stock | Estimated forest carbon | Automates |
| | | stock | |
| | | Ratio of biomass above | Automates |
| | | ground to below ground | |
| | | Determination of the | Automates |
| | | ecological zone | |
| | | BAU scenario carbon stock | Automates |
| | | Carbon stock in eligible | Performs |
| | | forestry (real) | |
| | Baseline | Deforestation rate | Automates |
| | | Deforestation risk | Automates |
| | | Projection of future | Automates |
| | | deforestation | |
| | | Project baseline | Automates |
| | | Project emissions | Performs |
| | | Potential generation of | Automates |
| | | APD credits | |
| | | Potential generation of | Automates |
| | | AUD credits | |
| | | Proof of additionality | Performs |
| | Co-benefits | Threatened Fauna and Flora | Automates |
| | | Species | |
| | Monitoring | Deforestation and fire alerts | Automates |
| | | Assessment of loss due to | Automates |
| | | deforestation and fire scars | |
| | | Retroactive credit analysis | Does not perform |
| | | Co-benefits for fauna | Does not perform |
| | | Co-benefits for social | Does not perform |
| | | Carbon | Does not perform |
| Report | Automation with | | Does not perform |
| | PD | | |
| Verifying | Discounts | Buffer | Automates |
| | | Leakage | Automates |
| | | | Under development |
| Origination and | | | (Decentralized Carbon |
| Sale of credit | | | Standard/internationally |
| | | | recognized registry) |

### Measurement

The measurement module showed herein aims to integrate solid and consistent geographic data, high-resolution satellite images and trained algorithms to understand forest dynamics that are fundamental to producing data close to those obtained in the field. With this, it is possible to manage territories and outline future patterns, such as deforestation risk, transforming complex and often decentralized data in several databases into valuable information that responds to the measurement, reporting, verification and monitoring steps of a REDD+ project, since the methodology, instruments and protocols are nationally and internationally recognized for measuring, reporting and verifying the reduction of carbon emissions due to forest deforestation and degradation, have the option of using blockchain to provide transparency, credibility and traceability.

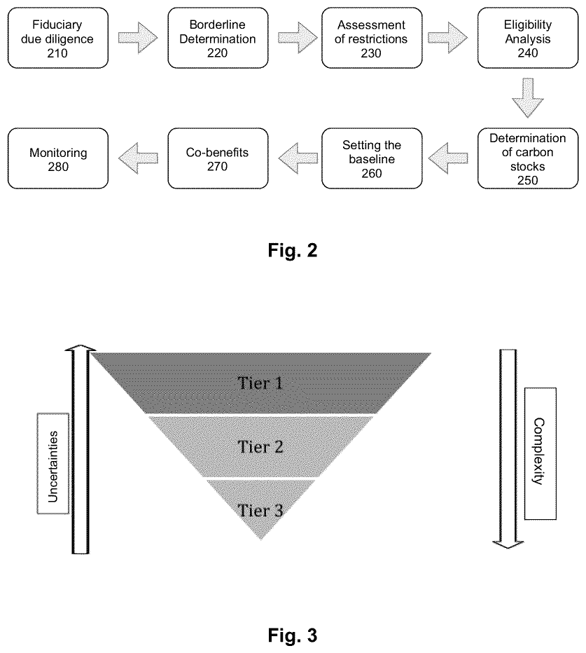

The system measurement module begins with the registration of the rural property or possession in the aforementioned system. FIG. 2 shows an exemplary flowchart of processing information according to one embodiment of the measurement module of the present invention.

To perform the steps as exemplified in FIG. 2, the system uses several data sources, which are public and private and obtained from geographic databases developed over years by agents from different sectors of the economy and based on robust methodologies, whether for the establishment of public policies or for the development of projects. Table 2 shows some examples of data sources used.

TABLE 2
Name and provider of the databases used

| Name | Data provider |
|---|---|
| Rural Environmental Registry (CAR) | Brazilian Forest Service |
| Land Management System (SIGEF) | National Institute of Colonization and |
| Settlements, Certified Properties | Agrarian Reform (Incra) |
| (SIGEF and SNCI) and Quilombolas | |
| Mapbiomas | Climate Observatory's Greenhouse Gas |
| | Emission Estimation |
| Alert MapBiomas | System |
| Global Water Surface | Jean-Francois Pekel, Andrew Cottam, Noel Gorelick, |
| | Alan S. Belward, High-resolution mapping of |
| | global surface water and its long-term changes. |
| | Nature 540, 418-422 (2016). |
| | Doi: 10.1038/nature20584 |
| A new high-resolution nationwide | ENGLUND et al. (2017) |
| aboveground carbon map for Brazil. | |
| RADD forest disturbance alert | Global Forest Watch |
| Burning Database | INPE |
| Carbon stock in pasture | IV National Inventory of Greenhouse Gas Emissions |
| | and Removals and its Technical Reference Reports |
| Red List of Threatened Species | International Union for Conservation of Nature |
| | (IUCN) |
| World Database on Protected | United Nations Environment Program World Conservation |
| Areas - WDPA | Monitoring Center (UNEP-WCMC) & International Union |
| | for Conservation of Nature (IUCN) |
| Key Biodiversity Areas - KBA | BirdLife International |

The system centralizes all geographic data in a single digital tool through the automation of data consultation, obtaining, treating, processing and systematization activities. Such centralization improves the performance of teams of specialists in the development of REDD+ projects, mainly in the land sector; and facilitates data observation by investors and auditors, providing robustness, trust and transparency.

In the development of carbon credit projects, mainly in the AFOLU (Agriculture, Forestry and Other Land Use) sector, ex-ante carbon measurement, that is, projections of removals or emissions of greenhouse gases greenhouse effect (GHG) before performing project activities and consolidating this data can become one of the most expensive and longest steps. The IPCC (Intergovernmental Panel on Climate Change) Good Practice Guide defines three levels of complexity in obtaining data and estimating ex-ante reductions, as can be seen in FIG. 3: level 1, which uses default values proposed by the IPCC; level 2, which uses national values with own estimates; and level 3, which uses more elaborate methods such as modeling and which must be compatible with the other levels. The present invention centralizes geographic and official data from levels 2 and 3, evaluates the additionality of the REDD+ intervention, adapts the scale of analysis to the territory of interest and applies the ex-ante implementation phase.

The system queries information processing methods configured to perform functions such as detecting forest disturbances, geospatial analysis to determine eligible forest area, and classifying each spectral response into land use categories such as pasture, agriculture, urban infrastructure, hydrology and native vegetation.

After receiving the rural property registration information and official property documents, represented as the land due diligence step (210) in the flowchart in FIG. 1, the system measurement module calculates the total area of the property (220) and evaluates the level of land regularity in the area (230), using the SICAR and SIGEF databases, thus continuing with the steps in the flowchart in FIG. 1.

The National Rural Environmental Registry System (SICAR) is a national electronic public registry that is mandatory for all rural properties in Brazil and is extremely important for understanding Brazilian territorial, land and environmental dynamics. To register with SICAR, the owner of the rural property needs to present identification by means of a plan and descriptive memorial containing the geographic coordinates with at least one mooring point on the perimeter of the property and the location of relevant areas, such as native vegetation remnants, Permanent Preservation Areas, Restricted Use Areas, consolidated areas and the location of the Legal Reserve (Article 19 of the Forest Code).

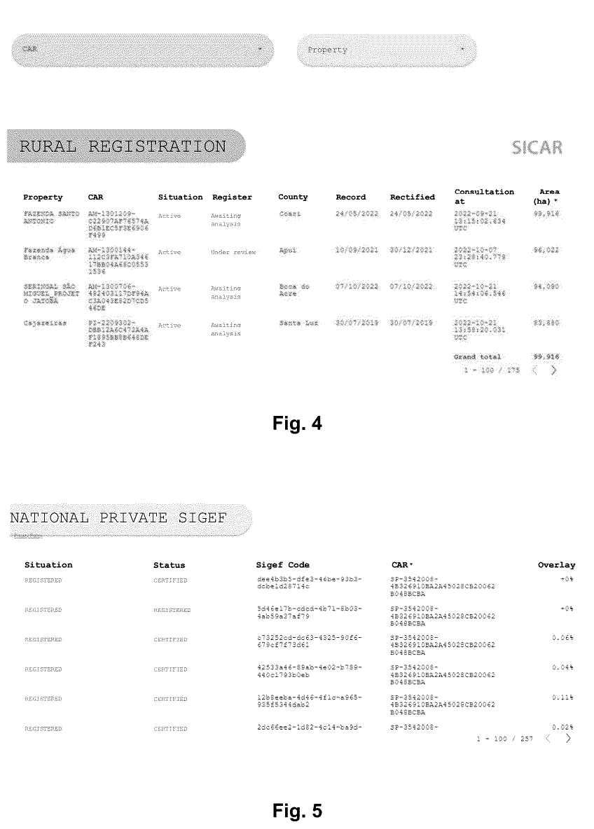

By routinely consulting the SICAR database, the digital measurement, reporting and verification system integrates environmental information on rural properties and possessions, composing a database for environmental control, monitoring, planning and combating deforestation. In this way, the consultation of the polygon area of the rural property and all its sets of information relevant to the area of interest for the REDD+ project is automated, reducing the human effort of operationalizing SICAR, extracting geographic data and systematizing information registrations. An example of the presentation of information made by the system, after extraction from the SICAR database is seen in FIG. 4.

SIGEF performs the reception, validation, organization, regularization and availability of georeferenced information on the boundaries of rural properties, supporting land governance throughout the national territory. More than 889 thousand parcels of rural properties have already been certified since the launch of the system in November 2013. Using the CPF [Individual Taxpayer Registration Number] of the rural property holder, sent with the rural property registration information, the system consults the SIGEF. When crossing the limit of the rural property registered in the digital measurement, reporting and verification system digitized with certified information from SIGEF, the system automatically identifies whether there is any spatial overlap with other properties or protected areas. This consultation is daily and includes the following steps: assessment of whether the property is based on private and non-public properties; assessment of georeferencing status and validation by the system; download of documents of the georeferenced area (plan and descriptive memorial); status of applications for certification, registration, dismemberment, remembrance, rectification and cancellation. FIG. 5 shows an example of information presented by the system based on the automatic query performed in SIGEF.

In another aspect of the invention, the system further comprises a carbon stock estimation step (250) ex-ante of carbon stocks in above-ground and below-ground trees and non-tree woody biomass for the baseline scenario, determining thus pre- and post-deforestation carbon stocks, estimate.

Estimating carbon stock plays a vital role in implementing agriculture, forestry and land use (AFOLU) projects. This phase is essential for the projection of carbon credit generation through the implementation of REDD+ project actions and the analysis of its financial viability.

The carbon storage potential varies according to abiotic factors, such as the local hydrology pattern, soil (minerals and nutrients), climate (temperature, light and water), geology and others. These attributes, in turn, have already been mapped and studied over the years by academia, and related to the carbon stock of vegetation. However, three important weaknesses are observed in the carbon maps for the Amazon Forest: (i) overestimation of carbon values in general; (ii) coarse resolution and limited spatial variability, and (iii) high degree of patchiness, with carbon values changing significantly from one map scene to another (ENGLUND et al., 2017).

To determine the carbon storage potential, the system uses the scientific study performed by Englund et al. (2017), which consolidates six of the main carbon maps of the Brazilian Amazon, weighting all these carbon stock estimates. This consolidated database is used to estimate the average carbon stock and standard deviation of the area of interest. Aiming for a conservative estimate, the lower limit of the established confidence interval is used.

Subsequently, the conversion of biomass above ground to below ground is carried out. This is done through the proportion of the root to the aerial part appropriate to the biome type, according to default values determined by the AFOLU Guidelines (IPCC 2006). To determine the domain and ecological zone of the analyzed territory, the FAO ecological classification maps (Global Ecological Zones) are used. Table 3 shows a ratio of below-ground biomass to above-ground biomass.

TABLE 3
Ratio of below-ground biomass to above-ground biomass (Source: IPCC, 2006)

| | | | R | |
|---|---|---|---|---|
| | | | \|tonne root | |
| | | Above-ground | d.m. (tonne | |
| Domain | Ecological zone | biomass | shoot d.m.) [symbol] \| | References |
| Tropical | Tropical rainforest | | 0.37 | [symbol] 1973 |
| | Tropical moist | above-ground biomass | 0.20 (0.09-0.25) | Mokany et al., 2006 |
| | deciduous forest | [symbol] | | |
| | | above-ground biomass | 0.24 (0.22-0.33) | Mokany et al., 2006 |
| | | [symbol] | | |
| | Tropical dry forest | above-ground biomass | 0.56 (0.28-0.68) | Mokany et al., 2006 |
| | | [symbol] | | |
| | | above-ground biomass | 0.28 (0.27-0.28) | Mokany et al., 2006 |
| | | [symbol] | | |
| | Tropical shrubland | | 0.40 | Poupon, 1980 |
| | Tropical mountain system | | 0.27 (0.27-0.28) | [symbol] 1994 |
| Subtropical | Subtropical humid forest | above-ground biomass | 0.20 (0.09-0.25) | Mokany et al., 2006 |
| | | [symbol] | | |
| | | above-ground biomass | 0.24 (0.22-0.33) | Mokany et al., 2006 |
| | | [symbol] | | |
| | Subtropical dry forest | above ground biomass | 0.56 (0.28-0.68) | Mokany et al., 2006 |
| | | [symbol] | | |
| | | above-ground biomass | 0.28 (0.27-0.28) | Mokany et al., 2006 |
| | | [symbol] | | |
| | Subtropical steppe | | 0.32 (0.26-0.71) | Mokany et al., 2006 |
| | Subtropical mountain | | no estimate | |
| | system | | available | |

[symbol]

indicates data missing or illegible when filed

Additionally, pasture carbon stock data is obtained to determine the net changes in carbon stock in the baseline, being represented by the pre-deforestation forest stock minus the carbon stock of likely land use after deforestation, commonly pasture. It is considered that the other carbon reservoirs in plant biomass do not have stored carbon, representing a conservative estimate.

Understanding land use and occupation from satellite images supports the understanding of the historical anthropic pressure, status and trends of the studied territory, as well as facilitating the social-economic and ecological management of the region. For REDD+ projects, it is necessary to understand the dynamics of land use and occupation in the region of the target territory, mainly in relation to the vectors and agents of deforestation.

With this, the digital measurement, reporting and verification system uses the mapping performed by the Annual Mapping Project of Land Use and Coverage in Brazil, MapBiomas, which is a multi-institutional initiative formed by NGOs, universities and technology companies to generate annual maps of land use and cover based on automatic classification processes applied to satellite images. This Brazilian system is extremely robust for verifying land use and occupation maps from native to non-forest conversion, in a significantly cheaper, faster and more updated way compared to current methods and practices.

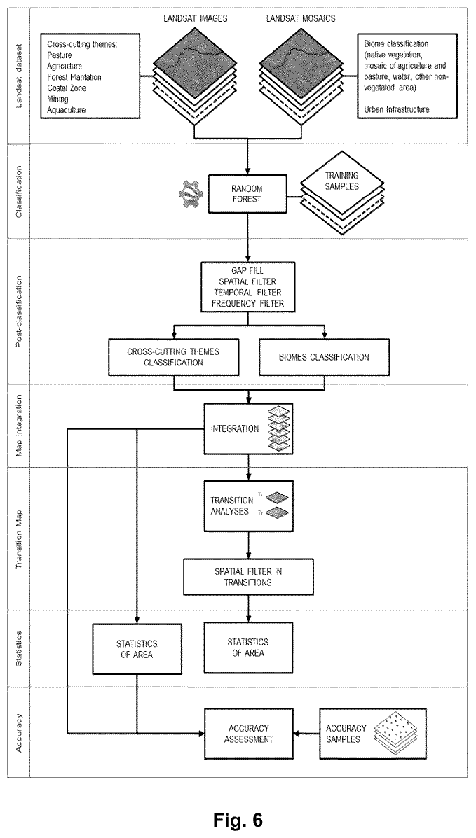

Remote sensing data coming from historical collections of Landsat satellite images produced by NASA (National Aeronautics and Space Administration) and USGS (United States Geological Survey) with a resolution of 30 m and formed by the RGB (red, green, blue) standard are used as input. Subsequently, indices are calculated to facilitate the interpretation of these images, such as NDFI, NDVI and NPV, aiming to automate the process of discriminating land use classes. Finally, cloud processing is performed through the application of a trained algorithm that classifies each spectral response into land use categories, such as pasture, agriculture, urban infrastructure, hydrology and native vegetation. Furthermore, some local samples are obtained to calibrate the information processing method in relation to reality. This process guarantees the quality of image classification and the reduction of errors. The steps of the methodology for implementing the MapBiomas land use and cover classification in Google Earth Engine (taken from Souza et al., 2020, Reconstructing Three Decades of Land Use and Land Cover Changes in Brazilian Biomes with Landsat Archive and Earth Engine-Remote Sensing, Volume 12, Issue 17, 10.3390/rs12172735), can be seen in FIG. 6.

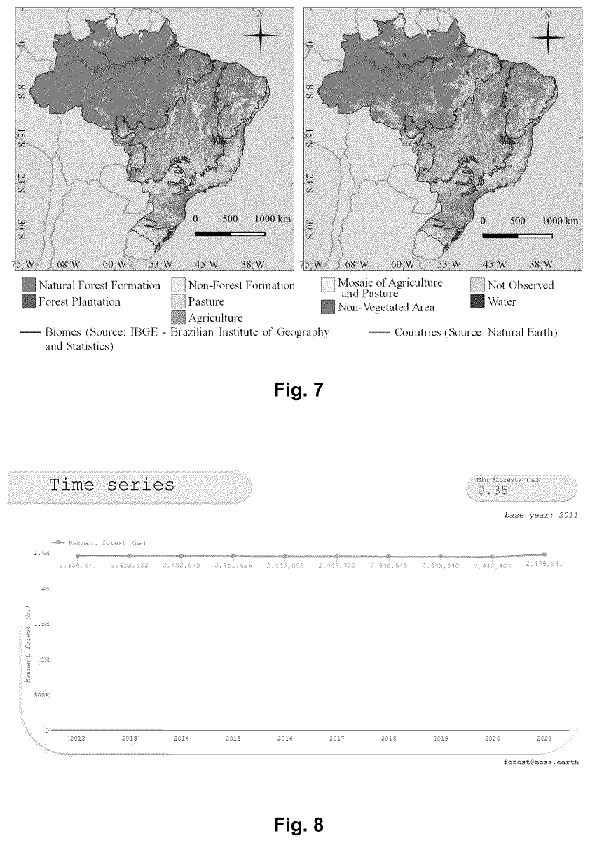

As a result of the land use and cover classification methodology, a mosaic is obtained with the final land use and vegetation classes for each year in matrix format (30×30 m pixel), used to calculate deforestation observed in the territories studied. The result of land cover and use in 1985 and 2017 in Brazilian biomes can be seen on the map in FIG. 7 as described by Souza et al., 2020.

For the purposes of certifying a forest carbon project, it is necessary to assess the eligibility of the forest area in relation to the methodology adopted in terms of forest definition. Therefore, based on the classification of land use, presented in the previous item, the system makes some adjustments via code development with Google Earth Engine and other “GIS” (Geographic Information System) software to align with forest eligibility criteria for avoided deforestation projects.

In this way, a geospatial analysis method is used determining the eligible forest area (240) by excluding the following areas:
non-forest natural formations (flooded field and swampy area, grassland formation, apicum, rocky outcrop and herbaceous sandbank) and savanna formations, mangroves and wooded sandbank;
areas identified as forests less than 10 years old. This criterion is generally used to prevent areas of secondary forest vegetation that are fallow between agricultural production cycles from being considered as forests.

This geospatial processing is performed using code in Google Earth Engine for all years between the two historical periods defined to determine the eligible forest area and calculate the deforestation rate in the district (municipality), a process foreseen in the baseline definition (260), according to the methodology for generating carbon credits through REDD+ adopted. This identifies the historical behavior of land use and forests to determine the deforestation baseline and the projection of the generation of carbon credits for avoided deforestation. FIG. 8 shows an example of presentation of information on remaining and eligible forest area between the two historical years of analysis, according to an execution embodiment of the present invention.

Considering the importance of generating co-benefits through REDD+ projects, mainly regarding the remuneration of biodiversity conservation work linked to the forest carbon project, the system also consults data sources related to the topic and automates the assessment of impacts on biodiversity. In this way, valuable information is provided regarding the potential for change of a carbon project in the evaluated territory, the potential for obtaining co-benefit certifications, which commonly add value to REDD+ projects, and, therefore, for decision making optimized.

In this way, the three globally recognized databases on the characteristics of biodiversity conservation in a territory are automatically consulted, namely:
IUCN Red List of Threatened Species: catalog of the conservation status of species of plants, animals, fungi and protozoa from across the planet based on the most up-to-date list;
World Database on Protected Areas: Global database on terrestrial and marine protected areas collected from international convention secretariats, governments and collaborating NGOs. The IUCN definition of a protected area is used as the main criteria for entries to be included in the database; and
World Database of Key Biodiversity Areas (KBA): Database of locations that contribute significantly to global biodiversity, covering terrestrial, freshwater and marine ecosystems. A KBA must meet one or more of eleven criteria, grouped into five categories, presented below: threatened biodiversity; geographically restricted biodiversity; ecological integrity; biological processes; and irreplaceability.

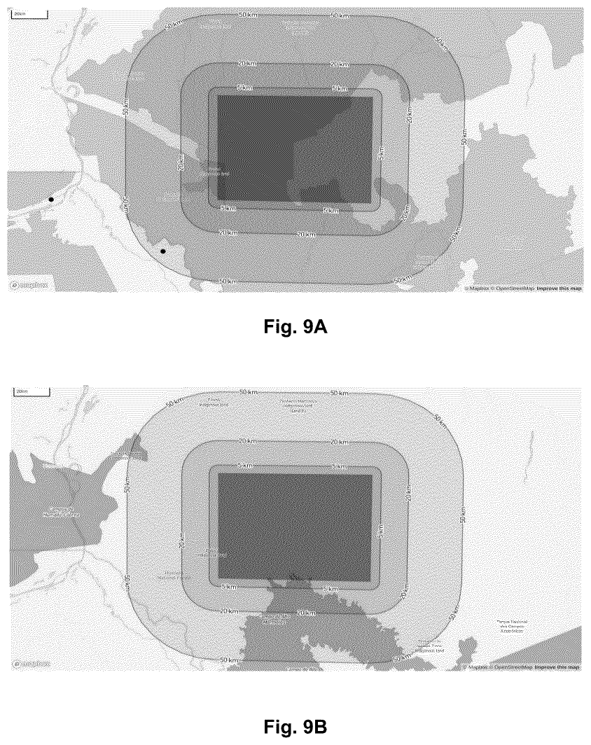

These databases are periodically updated and maintained by IBAT (Integrated Biodiversity Assessment Tool), an online data subscription platform for access to global biodiversity datasets, which is included in the system of the present invention, which identifies any overlaps of such attributes to the project area and the 5 km, 20 km and 50 km buffers, an example of the project area and 5, 20 and 50 km buffers with WDPA and KBA analysis can be seen in FIGS. 9A and 9B, respectively (Source: IBAT Proximity Report. Generated under license 30524-34003 from the Integrated Biodiversity Assessment Tool on 3 Sep. 2022 (GMT). www.ibat-alliance.org).

In this way, the system evaluates the potential impact on the territory's biodiversity, a process in the co-benefits step (270) of the REDD+ project, speeding up the assessment of the feasibility of implementing a REDD+ project; in obtaining primary data on site by the technical team specialized in faunal groups; in optimizing the field assessment of threatened species; and also during the preparation of reports to possibly obtain co-benefit certifications, such as CCB (Climate, Community and Biodiversity) and SD Vista (Sustainable Development Verified Impact Standard).

To predict the risk of deforestation and identify areas of future deforestation in the AUD modality, a process foreseen in the definition of the baseline (260), the spatial statistical modeling of “Forest at Risk”, recommended by the World Bank is used as the spatial model for predicting deforestation in 92 countries, covering all tropical rainforests in the world. Due to the territorial extension of Brazil and the complexity of analysis linked to this continental characteristic, the analysis is performed by state. The interactive map resulting from the modeling is available at https://forestatrisk.cirad.fr/maps.html and its respective scientific article is cited as Vieilledent et al. (2022).

This model is derived from high-resolution images and built based on factors linked to the existence of deforestation in tropical forests, such as: topography (altitude and slope), accessibility (distances to the nearest road, city and river), forest landscape (distance to the edge of the forest), historical deforestation (distance to past deforestation) and land conservation status (presence of a protected area). Such spatial variables, observed in the 2010s, are used as predictors to train the model to predict deforestation risk data and future forest cover under a business as usual (BAU) scenario.

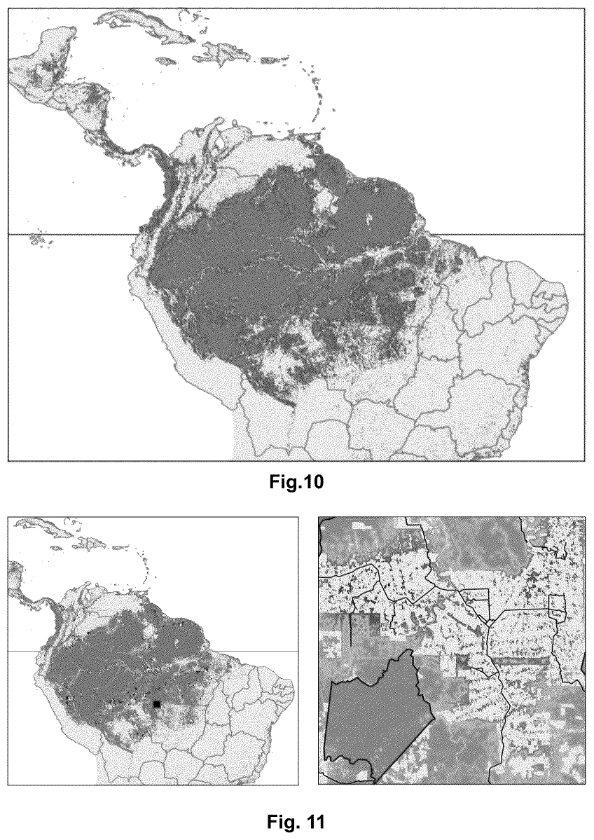

In this way, the model predicts the change in forest cover determining the baseline, a crucial step for avoided deforestation projects and programs. Maintaining the observed deforestation and considering the remaining forest in 2020, Brazil's BAU scenario could lose 40% of forest cover during the 21st century and, in the year 2204, the country would have 75% of its remaining forest cover disappeared. FIG. 10 shows the high-resolution map of the predicted change in tropical forest cover in America for the period 2020-2100, in a BAU scenario, wherein the deforested areas predicted for 2100 are in red and the forest areas existing in 2100 are in green (source: Vieilledent et al., 2022).

FIG. 11 shows the map of the probability (risk) of deforestation in the Amazon, that is, where the flow of deforestation intersects with the carbon stock. Dark red forest areas have a higher risk of deforestation than green forest areas. It is possible to observe that the probability of deforestation is lower within protected areas (black polygons) and increases when the forest is located close to roads (dark gray lines). Therefore, the system of the present invention selects pixels with a high risk of deforestation to determine the area of future deforestation in the eligible forest of the analyzed territory.

The assessment of the carbon credit generation potential used by the system of the present invention considers all previous processes to identify the forest area eligible for generating carbon credits arising from avoided, planned and unplanned deforestation.

For the planned deforestation potential (APD) process foreseen in the baseline definition step (260), the area that is legally authorized for deforestation is that identified as a Legal Reserve. The percentage of rural properties registered as Legal Reserve varies according to the biome, being: 80% in properties located in forest areas in the Legal Amazon; and 35% in properties located in Cerrado areas in the Legal Amazon. Based on these and other guidelines included in the Forest Code, the rural owner determines the location of his legal reserve on his property, which must be registered in the rural environmental registry (CAR) and approved by the competent environmental body. However, most of the time there is no approval of the location of the reserves. In this way, the system determines the possible legal reserve area based on the defined percentage overlapping the eligible forest area. This value is, finally, divided by ten years of APD credit generation.

For the unplanned deforestation (AUD) modality, the methodology for calculating the potential for generating carbon credits is different. Based on the “deforestation risk” processes presented, they overlap the eligible forest map, which will result in an estimate of the absolute deforested area for the year 2050.

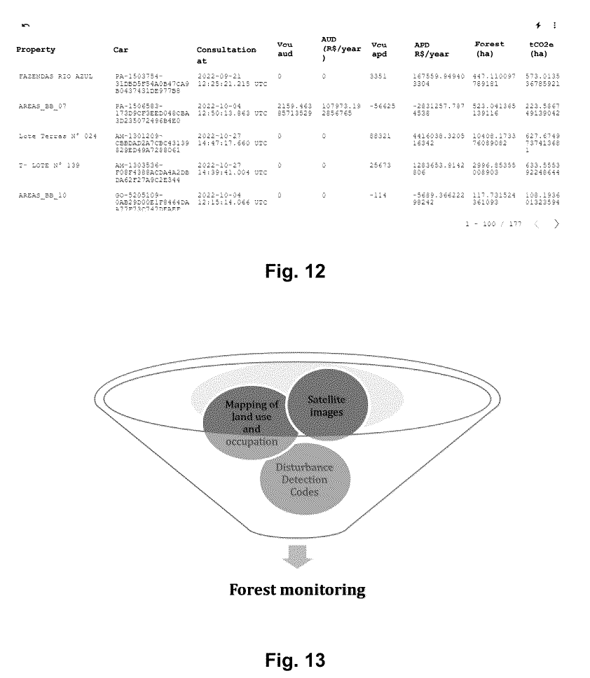

The system of the present invention also indicates situations in which the area of interest has the potential to generate carbon credits in both APD and AUD modalities. FIG. 12 shows an example of the system's presentation of the data obtained regarding the potential for generating APD and AUD credits in the area of interest.

Furthermore, for the purpose of analyzing the risk of non-permanence of carbon reservoirs, whether due to illegal deforestation, fires or natural disasters, the system applies a 20% automatic “buffer”. For an increase in GHG emissions or a decrease in removal outside the project limits that occurred due to project actions, known as leakage, the system applies a 10% discount. To estimate the gross revenue resulting from the implementation of the project, economic factors are defined such as the current value of the credit, the exchange rates for Real (Brazilian currency) and the percentage of the owner's participation in the revenue sharing.

In another aspect of the invention, the monitoring step (280) performed by the system includes inputs for forest monitoring, as exemplified by FIG. 13, and aims to: 1) identify forest areas converted into non-forest areas and the associated changes in carbon stocks; 2) forest areas that have suffered loss of carbon stocks due to degradation activities and changes in carbon stocks; 3) forest areas in the process of gaining carbon stocks from breeding activities and associated changes in carbon stocks.

The providers of this data are automatically consulted, according to the periodicity of information availability, and overlapped with the rural properties registered in the system. If alerts are identified in any monitored area, it is immediately communicated in the management and communication system of the system monitoring team, speeding up the on-site inspection process and communication to interested parties.

The deforestation and hot spot alerts consulted are obtained from the Deforestation Monitoring Project in the Legal Amazon by Satellite and the Burning and Forest Fire Monitoring Program of the National Institute for Space Research (INPE) and RADD Alerts.

The system also uses MapBiomas Alert, which is a system for validating and refining native vegetation deforestation alerts in all Brazilian biomes using high-resolution images. It is a partnership with user government agencies (e.g., MMA, IBAMA, SFB, ICMBio, MPF and TCU) and providers and their systems that originate alerts (e.g., DETER/INPE, SAD/IMAZON, GLAD/University of Maryland, ISA).

The MapBiomas code is automatically consulted and its alerts are superimposed on properties registered in the system. Such alerts have a minimum area of 0.3 hectares and are validated by visual inspection and, subsequently, for each one a high-resolution image from before and another after deforestation is selected. Planet images (daily passage and 3.5 meters of spatial resolution) or Sentinel-2 images (weekly passage, 10 meters of resolution) are used. The delimitation is refined using machine learning algorithms and cloud processing on the Google Earth Engine platform.

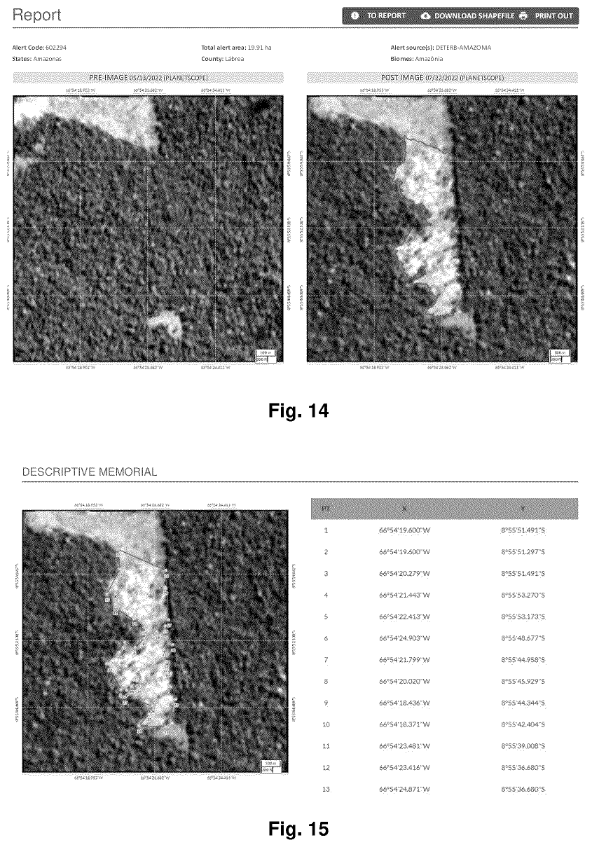

Using the MapBiomas system, the digital measurement, reporting and verification system traces the deforestation warning polygons and the respective deforestation reports, as seen in FIG. 14. In addition, the system prepares the descriptive memorial of the deforested area, as seen in FIG. 15. The report also informs the pressure vector detected for the alert area and whether there is any overlap between the deforested polygon and the areas legally deforested by IBAMA or by the state of Mato Grosso and Para. For the rest of the states in the Legal Amazon, there is no geographic data available on authorizations for alternative use and vegetation suppression.

INPE's Burning Program performs research, technological development and innovation of products, processes and geoservices for monitoring and modeling the occurrence and propagation and classification of active fire in vegetation, its risk, extent and severity, using Remote Sensing techniques, Geoprocessing and Numerical Modeling.

The Program uses hot spot detection algorithms in near-real time (24 hours) from various satellite image sources (Terra, Aqua, Suomi NPP, NOAA-15, NOAA-18, NOAA-19, Metop-B, GOES-16 and Meteosat-10 MSG-3). The existence of a hot spot is an excellent indicator of the occurrence of fire and its rapid detection, often enabled by the use of this range of images and fire detection data, increases the level of monitoring and prevention of front advances of fire in REDD+ project areas.

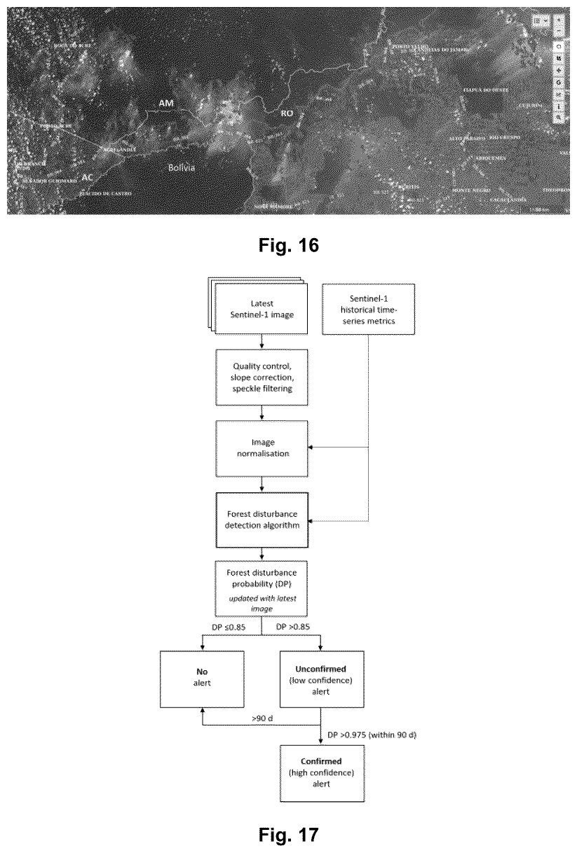

FIG. 16 presents an image wherein it is possible to observe the detection of burning vegetation and other hot targets by the various satellites used to monitor fire outbreaks in REDD+ projects of the system of the present invention, in which records are stored hourly in the Fire Database that compiles the historical base of outbreak detections from 1998 to the present. Therefore, in addition to forest monitoring, the use of INPE data also corroborates previous and non-permanent analyzes of the historical risk of reversing the carbon stored in the analyzed area.

The present invention uses the “Burning Program” database, extracting the polygons of each alert and crossing these polygons from the registered rural property with the aim of checking whether there is a fire alert on the rural property of interest. Data from the Burning Program is collected daily, checked in the database of rural properties, monitored and reported via slack.

Still, in another aspect of the invention, the digital measurement, reporting and verification system uses the RADD (Radar for Detecting Deforestation) system. RADD is an initiative of Wageningen University, in collaboration with the World Resources Institute's Global Forest Watch program, Google, the European Space Agency and the University of Maryland and Deltares. The alert system is based on the Sentinel-1 satellite and implemented in Google Earth Engine to map new disturbances in the forest. With visits to areas every 6-12 days and 10 m resolution of satellite images, this system uses a detection method that identifies forest disturbances in near real time, defined as the complete or partial removal of tree cover within a 10 m×10 m (0.01 ha) pixel. FIG. 17 illustrates the flowchart of the forest disturbance detection method using Sentilnel-1 images (source: Reiche et al. (2021), Forest disturbance alerts for the Congo Basin using Sentinel-1, Environmental Research Letters). RADD is an additional source that can be used to facilitate checking, in addition to acting as a redundant source of information, so that the digital measurement, reporting and verification system gains robustness and reliability. Thus, the Burning Program, RADD and MapBiomas alert work together to provide greater reliability and robustness to the system.

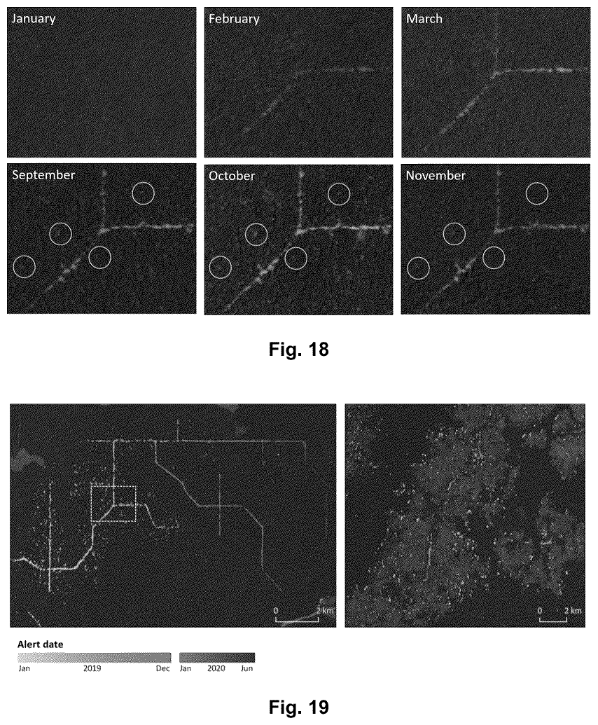

Complete removal of tree cover is associated with disturbance from stand replacement at the Sentinel-1 pixel scale, while partial removal mainly represents disturbances associated with boundary pixels and selective logging. RADD is a superior system to currently operational ones that are predominantly dependent on satellite data of medium resolution of 30-100 m and with long temporal intervals of visits to areas. With RADD alerts, even small disturbances in the forest are detected due to selective cutting, often preceding clear cutting and not detected by other satellites due to rapid forest regeneration and the slow revisit of the satellite in that same location, dynamics observed in FIG. 18, wherein it is possible to observe the dynamics of logging road expansion (January, February, March), followed by selective logging (September and October) and rapid canopy closure (November). Circles indicate canopy opening after extraction (October) and canopy closure within one to two months (November). (Source: Reiche et al. (2021)).

In this way, properties registered in the system are now consistently and routinely monitored and any detection of deforestation or even illegal logging can be better monitored. Another example of detection can be seen in FIG. 19, wherein road logging expansion is observed and selective wood extraction (Source: Reiche et al. (2021)).

### Reporting

After each monitoring step, a report must be submitted for registration, containing the description and references used, as well as all the results obtained and their basic information for each step presented in this document, according to the “Monitoring Information Template” or the “Project Monitoring Report”. The Monitoring Report must describe the current status of the operation project, and include the monitored data, description of measurement methods, monitoring plan, calculated emission reductions and ecological indicators for the period indicated in the Credit Class and following the guidelines of Methodology.

For results with Geographic Information System (GIS) or remote sensing data, maps must be included as images in the report for illustrative purposes. The original vector and raster files must be kept by the proponent, as well as any documentation containing calculations and statistical analyses. All data used during the analysis must be maintained throughout the monitoring period. This data includes: all raster and vector data used in geospatial analysis to generate results for any section of the methodology; relevant field data from the forest inventory process; documentation describing calculations and results of statistical analyses.

### Verifying

Verification is a systematic, independent, documented evaluation by a qualified professional and impartial third party of benefit claims for a specific reporting period. The Verifier is an individual or organization contracted to perform verification of stipulated requirements approved by an internationally recognized registry.

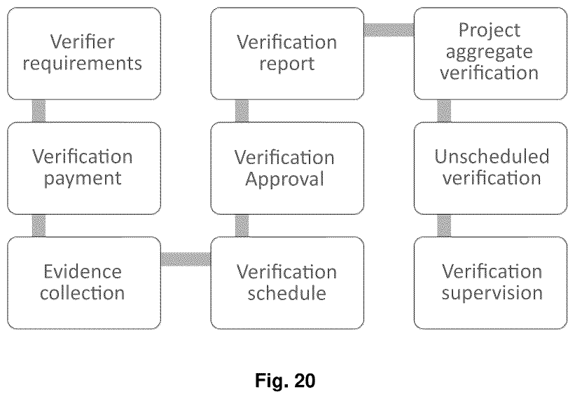

The validation step is not necessary, as internationally recognized registries do not require an ex-ante estimate of reduced emissions from the Project. Instead, the Verifier validates the project's eligibility according to the rules defined in the Program Guide. The verification process follows the steps shown in the flowchart in FIG. 20. The issuance and sale of certificates will be defined in the Decentralized Carbon Standard (DSC) Credit Class with an internationally recognized registry.

In this way, through the application of data programming and geographic and environmental intelligence, the digital measurement, reporting and verification (MRV) system that helps in evaluating the technical-financial viability of REDD+ projects both in the planned deforestation modality and of unplanned.

The system of the present invention is capable of optimizing and speeding up the development of REDD projects, preventing good projects from not being developed due to some initial understanding of low additionality or average carbon yield. This is achieved by centralizing multiple databases, satellite images and scientific studies into a single repository; and the automation and digitalization of the steps necessary to develop an avoided deforestation project, such as land tenure due diligence for the territory, collecting data in the field to estimate carbon density in biomass and estimating the generation of carbon credits, whether in the form of planned or unplanned deforestation. Therefore, the present invention has nationally or internationally recognized methodologies, instruments and protocols for measuring, reporting and verifying the reduction of carbon emissions due to deforestation and forest degradation and has the option of using blockchain being capable to provide transparency, credibility and traceability.

It is to be understood that the present description does not limit the application to the details described herein and that the invention is capable of other embodiments and of being practiced or performed in a variety of ways within the scope of the claims. Although specific terms have been used, such terms should be construed in a generic and descriptive sense and not for the purpose of limitation.

1. A SYSTEM OF DIGITAL MEASUREMENT, REPORTING AND VERIFICATION with secure information storage and processing system, characterized in that said system uses:
official databases;
satellite images; and
algorithms;
wherein the system further comprises at least one:
a measurement module, configured to receive information from rural property registration, to perform the total calculation of the property, to evaluate the level of area land regularity using the databases and to estimate the carbon stock;
a reporting module, configured to generate monitoring reports; and
a verification module, configured to provide the necessary information for the Verifier to evaluate the stipulated requirements;
wherein said modules work in an automated way and record information in a secure information storage and processing system, preferably in blockchain.

2. The SYSTEM, according to claim 1, characterized in that the database are selected at least from the group comprising: Rural Environmental Registry (CAR); Land Management System (SIGEF); Settlements, Certified Properties (SIGEF and SNCI) and Quilombolas; Mapbiomas; MapBiomas Alert; Global Water Surface; A new high-resolution nationwide aboveground carbon map for Brazil; RADD forest disturbance alert; Burning Database; Carbon stock in pasture; Red List of Threatened Species; World Database on Protected Areas (WDPA); and the World Database of Key Biodiversity Areas (KBA).

3. The SYSTEM, according to claim 1, characterized in that the system is configured to detect forest disturbances.

4. The SYSTEM, according to claim 1, characterized in that the system is configured to perform geospatial analysis to determine the eligible forest area.

5. The SYSTEM, according to claim 1, characterized in that the system is configured to classify each spectral response into land use categories, such as pasture, agriculture, urban infrastructure, hydrology and native vegetation.

6. The SYSTEM, according to claim 1, characterized in that the measurement module comprises a land due diligence step, wherein the registration of a natural or legal person is automated.

7. The SYSTEM, according to claim 1, characterized in that the measurement module comprises a spatial limits step, wherein the calculation of the total area of the property is automated.

8. The SYSTEM, according to claim 1, characterized in that the measurement module comprises a restriction step, wherein registration in the rural environmental registration system and registration in the land management system are automated.

9. The SYSTEM, according to claim 1, characterized in that the measurement module comprises an eligibility step, wherein the process of evaluating historical and current land use and evaluating eligible forest is automated.

10. The SYSTEM, according to claim 1, characterized in that the measurement module comprises a carbon stock estimation step, wherein the processes of estimating forest carbon stock, the ration of above-ground and below-ground biomass, ecological zone determination and BAU scenario carbon stock estimation are automated.

11. The SYSTEM, according to claim 1, characterized in that the measurement module comprises a baseline step, wherein the processes of assessing deforestation risk, deforestation projection, project baseline, potential APD credit generation and potential AUD credit generation are automated.

12. The SYSTEM, according to claim 1, characterized in that the measurement module comprises a monitoring step, wherein deforestation and fire alerts and the assessment of losses due to deforestation and fire scars are automated.

13. The SYSTEM, according to claim 1, characterized in that the verification module comprises a discount step, wherein for analysis of the risk of non-permanence of carbon reservoirs, a 20% automatic buffer is applied and for increased carbon emissions or reduced removal outside the project borderline a 10% discount is applied.
